(19) United States
(12) Patent Application Publication
(10) Pub. No.: US 2026/0010721 A1
(43) Pub. Date: Jan. 8, 2026

(54) INFORMATION PROCESSING APPARATUS, COVERAGE CONTENT VERIFICATION APPARATUS, STATEMENT DETAILS VERIFICATION APPARATUS, VERIFICATION METHOD, AND NON-TRANSITORY COMPUTER-READABLE STORAGE MEDIUM

(71) Applicant: NEC Corporation, Tokyo (JP)

(72) Inventors: Kazuya KAKIZAKI, Tokyo (JP); Yuto Matsunaga, Tokyo (JP); Ryo Furukawa, Tokyo (JP); Toshinori Araki, Tokyo (JP); Masaya Fujiwaka, Tokyo (JP); Junichi Funada, Tokyo (JP); Jianquan Liu, Tokyo (JP)

(73) Assignee: NEC Corporation, Tokyo (JP)

(21) Appl. No.: 19/245,536

(22) Filed: Jun. 23, 2025

(30) Foreign Application Priority Data
Jul. 4, 2024 (JP) 2024-108427

(51) Int. Cl. G06F 40/284

(52) U.S. Cl. CPC G06F 40/284

(57) ABSTRACT

An information processing apparatus includes a textualizing unit for textualizing a non-text element included in a content that is a target for determining authenticity of assertion details, an extraction unit for extracting assertion details of the content from the textualized non-text element, and an authenticity determination unit for determining authenticity of the extracted assertion details. According to this information processing apparatus, it is also possible to avoid making an erroneous determination based on content having erroneous details.

### INCORPORATION BY REFERENCE

This application is based upon and claims the benefit of priority from Japanese patent application No. 2024-108427, filed on Jul. 4, 2024, the disclosure of which is incorporated herein in its entirety by reference.

### TECHNICAL FIELD

The present disclosure relates to an information processing apparatus, a coverage content verification apparatus, a statement details verification apparatus, a verification method, and a verification program.

### BACKGROUND ART

Various contents such as news articles are published every day. Published contents may include contents including details contrary to the facts, such as fake news. An example of a technique as a countermeasure against such content is Patent Literature 1 as follows. The news distribution system disclosed in Patent Literature 1 requests a predetermined expert to perform fact checking on a news article. In this news distribution system, if positive evaluation is given to the result of the fact checking, the fairness score of the news article is added. As a result, a user can determine whether the news article is likely to be reliable with reference to the fairness score.
Patent Literature 1: Japanese Unexamined Patent Publication No. 2024-15904

### SUMMARY

Since it takes time, effort, and costs to perform the fact checking by an expert, it is desirable to automate the fact checking, in other words, the authenticity determination for the assertion details in the content. In recent years, many contents including non-text elements such as moving images and still images (hereinafter collectively referred to simply as images) have been published. Therefore, it is desirable to automatically determine the authenticity of the assertion details in consideration of the non-text element included in the content. However, such a technique is currently unknown.

The present disclosure has been made in view of the above problems, and an example object of the present disclosure is to provide a technique for automatically determining the authenticity of assertion details in consideration of a non-text element included in a content.

According to an example aspect of the present disclosure, an information processing apparatus includes textualizing means for textualizing a non-text element included in a content that is a target for determining authenticity of assertion details, extraction means for extracting assertion details of the content from the textualized non-text element, and authenticity determination means for determining authenticity of the extracted assertion details.

According to another example aspect of the present disclosure, a coverage content verification apparatus includes textualizing means for textualizing a non-text element included in a content that is a coverage target, extraction means for extracting assertion details of the content from the textualized non-text element, and authenticity determination means for determining authenticity of the extracted assertion details.

According to still another example aspect of the present disclosure, a statement details verification apparatus includes textualizing means for textualizing a non-text element of a content indicating statement details, extraction means for extracting the statement details from the textualized non-text element, and authenticity determination means for determining authenticity of the extracted statement details.

According to still yet another example aspect of the present disclosure, a verification method includes, by at least one processor, textualizing a non-text element included in a content that is a target for determining authenticity of assertion details, extracting assertion details of the content from the textualized non-text element, and determining authenticity of the extracted assertion details.

According to still yet another example aspect of the present disclosure, a verification program causes a computer to function as textualizing means for textualizing a non-text element included in a content that is a target for determining authenticity of assertion details, extraction means for extracting assertion details of the content from the textualized non-text element, and authenticity determination means for determining authenticity of the extracted assertion details.

According to an example aspect of the present disclosure, it is possible to exhibit an exemplary effect that it is possible to provide a technique for automatically determining authenticity of assertion details in consideration of a non-text element included in a content.

### BRIEF DESCRIPTION OF DRAWINGS

FIG. 1 is a block diagram illustrating a configuration of an information processing apparatus according to the present disclosure;

FIG. 2 is a flowchart illustrating a flow of a verification method according to the present disclosure;

FIG. 3 is a block diagram illustrating a configuration of another information processing apparatus according to the present disclosure;

FIG. 4 is a diagram illustrating an example of authenticity determination using an LLM;

FIG. 5 is a diagram illustrating an example of a report generated by a report generation unit;

FIG. 6 is a flowchart illustrating an example of processing performed by the information processing apparatus illustrated in FIG. 3;

FIG. 7 is a block diagram illustrating a configuration of a coverage content verification apparatus according to the present disclosure;

FIG. 8 is a block diagram illustrating a configuration of a statement details verification apparatus according to the present disclosure; and

FIG. 9 is a block diagram illustrating a configuration of a computer that functions as the information processing apparatus according to the present disclosure.

### EXAMPLE EMBODIMENT

Hereinafter, example embodiments of the present invention will be described. However, the present invention is not limited to the example embodiments described below, and various modifications can be made within the scope described in the claims. For example, example embodiments obtained by appropriately combining techniques (some or all of things or methods) adopted in the following example embodiments can also be included in the scope of the present invention. In addition, example embodiments obtained by appropriately omitting some of the techniques adopted in the following example embodiments can also be included in the scope of the present invention. In addition, effects mentioned in the following example embodiments are examples of effects expected in the example embodiments, and do not define the extension of the present invention. That is, example embodiments that do not achieve the effects mentioned in the following example embodiments can also be included in the scope of the present invention.

### First Example Embodiment

A first example embodiment that is an example of an example embodiment of the present invention will be described in detail with reference to the drawings. The present example embodiment is a basic form of each example embodiment to be described later. An application range of each technique adopted in the present example embodiment is not limited to the present example embodiment. That is, each technique adopted in the present example embodiment can also be adopted in the other example embodiments included in the present disclosure within a range in which no particular technical problem occurs. In addition, each technique illustrated in the drawings referred to for describing the present example embodiment can also be adopted in the other example embodiments included in the present disclosure within a range in which no particular technical problem occurs.

### (Configuration of Information Processing Apparatus)

A configuration of an information processing apparatus 1 will be described with reference to FIG. 1. FIG. 1 is a block diagram illustrating the configuration of the information processing apparatus 1. As illustrated in FIG. 1, the information processing apparatus 1 includes a textualizing unit 101, an extraction unit 102, and an authenticity determination unit 103.

The textualizing unit 101 textualizes a non-text element included in a content that is a target for determining the authenticity of assertion details. For example, as described in a second example embodiment to be described later, the textualizing unit 101 textualizes an image included in a news article on the Internet. Here, “content” includes at least a non-text element. The “non-text element” indicates data in a format other than the text format, and examples thereof include image data, video data, audio data, and the like. The content may include a plurality of types of non-text elements. Furthermore, the content may include a plurality of non-text elements of a specific type.

In a case where image data is included in the content, examples of information textualized by the textualizing unit 101 include information for specifying a person included in an image, information indicating a state of the person, information for specifying an object, information indicating a state of the object, information indicating a place, and information indicating a time, and the like.

Furthermore, in a case where audio data is included in the content, examples of the information textualized by the textualizing unit 101 include utterance details of human speech, information of ambient sound, information of music, and the like included in audio. Furthermore, in a case where video data is included in the content, examples of the information textualized by the textualizing unit 101 include various types of information corresponding to the above-described image data regarding the image included in the video, and various types of information corresponding to the above-described audio data regarding the audio included in the video.

Examples of a method of textualizing the details of an image include bootstrap language image pre-training (BLIP) and the like. Examples of a method of textualizing the details of the video include Video-LLaVa and the like. Examples of a method of textualizing the details of the audio include Whisper and the like. Examples of a method of extracting text in a video include an optical character recognition (OCR) technique such as vision transformer for fast and efficient scene text recognition (ViTSTR). For example, text may be generated from a non-text element by using a Vision Language Model or the like that receives a plurality of modalities as inputs and generates text.

The textualizing unit 101 may analyze the non-text element from some viewpoint by artificial intelligence (AI) instead of the details themselves of the non-text element, and textualize the analysis result. For example, the textualizing unit 101 may textualize the result by using AI that specifies the place based on the scenery included in the image or the video. The textualizing unit 101 may textualize the determination result by using AI that determines whether the image, the video, and the audio are media generated by deep fake or media generated by generation AI.

That is, the textualizing unit 101 may generate text information by at least one of information in which the details of the non-text element are textualized and information in which the result of analyzing the non-text element from some viewpoint is textualized.

The extraction unit 102 extracts assertion details of a content from the non-text element textualized by the textualizing unit 101. For example, as described in the second example embodiment to be described later, the extraction unit 102 extracts assertion details of a news article from a text obtained from an image included in the news article on the Internet. “Assertion details” are an assertion whose authenticity can be determined. In other words, the assertion details correspond to a concept, information, and the like that are assumed to be recognized by the recipient of a content receiving the content.

Specifically, the extraction unit 102 generates a prompt indicating that a text generated from one or more non-text elements included in the content by the textualizing unit 101 is used as an input and assertion details are used as an output, and inputs the generated prompt to a language model. Here, since it is also assumed that there is a plurality of assertion details depending on the content, the extraction unit 102 may generate a prompt that permits the plurality of assertion details to be output.

As the above language model, for example, a model in which the arrangement of constituent elements (such as words) in a sentence or the arrangement of a sentence and a sentence in a sentence are machine-learned may be applied. From the viewpoint of obtaining highly accurate output, it is particularly preferable to use a large language model (LLM) generated by machine learning using a large-scale language corpus. For example, a generative pre-trained transformer (GPT) that outputs a sentence including an input character string by predicting a character string having a high probability following the input character string can be used as the LLM used for extracting the assertion details. In addition, as the LLM used for extracting the assertion details, for example, text-to-text transfer transformer (T5), bidirectional encoder representations from transformers (BERT), robustly optimized BERT approach (ROBERTa), efficiently learning an encoder that classifies token replacements accurately (ELECTRA) and the like may be used.

The extraction unit 102 may access an LLM service provided on a cloud via a communication network and use the LLM service, or may use an LLM processing unit constructed in the information processing apparatus 1. The extraction unit 102 extracts the output result from the LLM as the assertion details.

The authenticity determination unit 103 determines the authenticity of the assertion details extracted by the extraction unit 102. For example, as described in the second example embodiment to be described later, the authenticity determination unit 103 determines the authenticity of the assertion details extracted from a news article on the Internet.

Specifically, the authenticity determination unit 103 generates a prompt indicating that at least a text indicating assertion details extracted by the extraction unit 102 and information as evidence of the authenticity determination is used as an input and the authenticity determination result of the assertion details is used as an output, and inputs the generated prompt to the LLM. The authenticity determination result may be indicated by a binary value of “true” or “false”, or may be indicated by evaluation results of a plurality of levels such as “true”, “slightly true”, “slightly false”, and “false”. As the authenticity determination result, the degree of likelihood of “true” may be indicated by a numerical value (0 to 100 or the like).

Examples of information as evidence of the authenticity determination include information (external information) existing on the Internet, information (internal information) stored in the information processing apparatus 1 or a private network in which the information processing apparatus 1 exists, and the like.

The authenticity determination unit 103 may access an LLM service provided on a cloud via a communication network and use the LLM service, or may use an LLM processing unit constructed in the information processing apparatus 1.

### (Effects of Information Processing Apparatus 1)

As described above, the information processing apparatus 1 adopts a configuration including the textualizing unit 101 that textualizes a non-text element included in a content that is a target for determining authenticity of assertion details, the extraction unit 102 that extracts assertion details of the content from the textualized non-text element, and the authenticity determination unit 103 that determines authenticity of the extracted assertion details. Therefore, according to the information processing apparatus 1, it is possible to obtain an effect that it is possible to automatically determine the authenticity of the assertion details in consideration of the non-text element included in the content. Furthermore, according to this information processing apparatus, it is also possible to avoid making an erroneous determination based on content having erroneous details.

### (Verification Program)

The above-described functions of the information processing apparatus 1 can also be implemented by a program. According to the present example embodiment, a verification program causes a computer to function as the textualizing unit 101 that textualizes a non-text element included in a content that is a target for determining authenticity of assertion details, the extraction unit 102 that extracts assertion details of the content from the textualized non-text element, and the authenticity determination unit 103 that determines authenticity of the extracted assertion details. According to this verification program, it is possible to obtain an effect that it is possible to automatically determine the authenticity of the assertion details in consideration of the non-text element included in the content.

### (Verification Method)

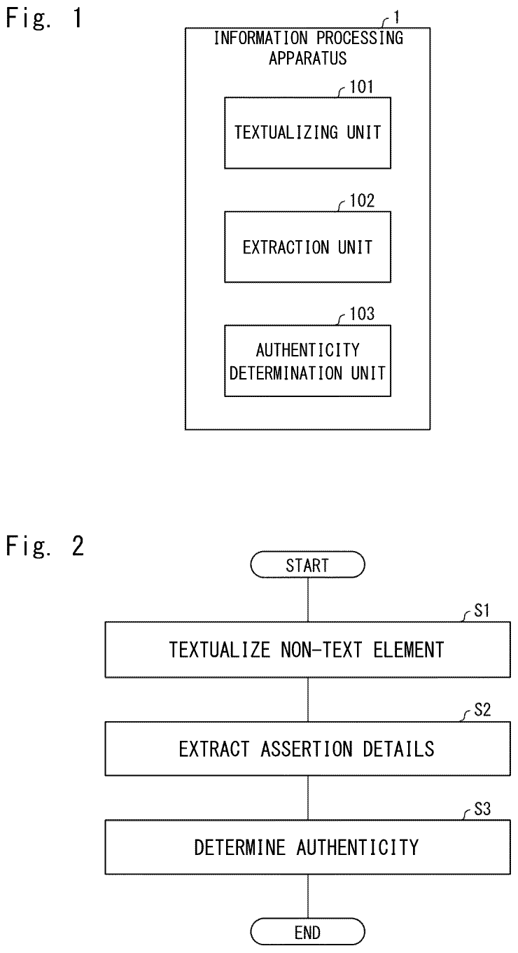

A flow of a verification method according to the present example embodiment will be described with reference to FIG. 2. FIG. 2 is a flowchart illustrating the flow of the verification method. An execution subject of each step in this verification method may be a processor included in the information processing apparatus 1 or may be a processor included in another apparatus, or execution subjects of the respective steps may be processors provided in different apparatuses.

In S1 (textualizing processing), at least one processor textualizes a non-text element included in a content that is a target for determining the authenticity of assertion details.

In S2 (extraction processing), at least one processor extracts the assertion details of the content from the non-text element textualized in S1.

In S3 (authenticity determination processing), at least one processor determines the authenticity of the assertion details extracted in S2.

### (Effects of Verification Method)

As described above, the verification method according to the present example embodiment adopts a method including, by at least one processor, textualizing a non-text element included in a content that is a target for determining authenticity of assertion details, extracting assertion details of the content from the textualized non-text element, and determining authenticity of the extracted assertion details. Therefore, with the verification method according to the present example embodiment, it is possible to obtain an effect that it is possible to automatically determine the authenticity of the assertion details in consideration of the non-text element included in the content.

### Second Example Embodiment

A second example embodiment that is an example of an example embodiment of the present invention will be described in detail with reference to the drawings. Components having the same functions as the components described in the above-described example embodiment are denoted by the same reference numerals, and the description thereof will be appropriately omitted. An application range of each technique adopted in the present example embodiment is not limited to the present example embodiment. That is, each technique adopted in the present example embodiment can also be adopted in the other example embodiments included in the present disclosure within a range in which no particular technical problem occurs. In addition, each technique illustrated in each of the drawings referred to for describing the present example embodiment can be adopted in the other example embodiments included in the present disclosure within a range in which no particular technical problem occurs.

### (Configuration of Information Processing Apparatus 1A)

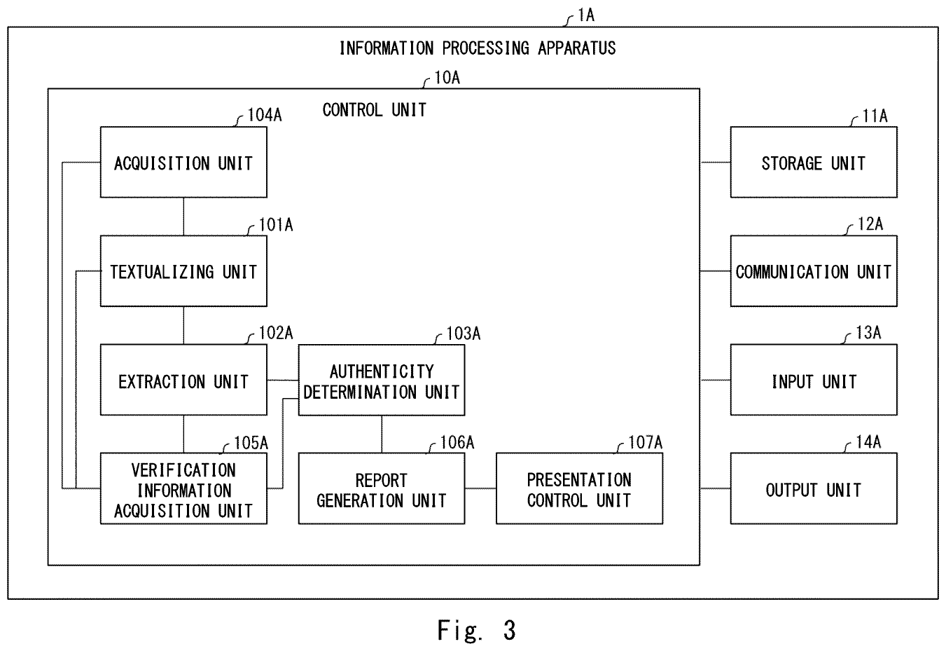

A configuration of an information processing apparatus 1A according to the present example embodiment will be described with reference to FIG. 3. FIG. 3 is a block diagram illustrating the configuration of the information processing apparatus 1A. The information processing apparatus 1A includes a control unit 10A that integrally controls units of the information processing apparatus 1A, and a storage unit 11A that stores various types of data to be used by the information processing apparatus 1A. Furthermore, the information processing apparatus 1A includes a communication unit 12A for the information processing apparatus 1A to communicate with another apparatus, an input unit 13A that receives an input to the information processing apparatus 1A, and an output unit 14A for the information processing apparatus 1A to output data. The control unit 10A includes an acquisition unit 104A, a textualizing unit 101A, an extraction unit 102A, an authenticity determination unit 103A, a verification information acquisition unit 105A, a report generation unit 106A, and a presentation control unit 107A.

The acquisition unit 104A acquires a content that is a target for determining the authenticity of the assertion details. For example, the acquisition unit 104A receives, from a user via the communication unit 12A or the input unit 13A, information for specifying a content that is a target for determining the authenticity of the assertion details, and acquires the content. The acquisition unit 104A may automatically acquire the content without manual operation. Examples of the information for specifying a content include uniform resource locator (URL) information indicating a specific page on the Internet, information for specifying a specific post on a specific SNS, and information indicating a storage location of a specific content file including content data.

The target content may be any content as long as the content includes some assertion details. For example, the target content may be a news article on the Internet, a message posted on an SNS or the like, audio/video data at the time of interrogation by the police, or the like. The target content may be limited to content in a specific field. For example, by limiting the target content to articles in the medical field, authenticity of technical details in the medical field can be verified. For example, by limiting the target content to a healthcare related document, it is also possible to verify the authenticity of the details related to healthcare.

Similarly to the textualizing unit 101 in the first example embodiment, the textualizing unit 101A textualizes a non-text element included in a content that is a target for determining the authenticity of the assertion details. Here, the textualizing unit 101A textualizes the non-text element included in the content acquired by the acquisition unit 104A.

The extraction unit 102A extracts assertion details of the content from the non-text element textualized by the textualizing unit 101 and a text element included in the content. Specifically, the extraction unit 102A generates a prompt indicating that a text generated from one or more non-text elements included in the content by the textualizing unit 101 and the text element included in the content are used as inputs and the assertion details are used as an output, and inputs the generated prompt to the LLM.

An example of the prompt includes details as follows. “A text input including a combination of a text, an image, audio, and a video is given. Your job is to comprehensively evaluate the given text input and accurately determine and extract an assertion included in the input. Here, the assertion is an assertion whose authenticity can be determined. In a case where a plurality of assertions are included in the input, please extract all assertions”

The above prompt includes at least one of a text corresponding to the image, a text corresponding to the video, and a text corresponding to the audio, which are textualized by the textualizing unit 101A. Also, in a case where the content includes a text element, the text element is also included in the prompt. If such a prompt is input to the LLM, the assertion details of the content are output from the LLM.

The extraction unit 102A may access an LLM service provided on a cloud via a communication network by the communication unit 12A and use the LLM service, or may use an LLM processing unit constructed in the information processing apparatus 1A.

The verification information acquisition unit 105A acquires verification information as a basis of the authenticity determination by the authenticity determination unit 103A based on at least one of the text generated by the textualizing unit 101A, the text as the text element included in the content acquired by the acquisition unit 104A, and the non-text element included in the content acquired by the acquisition unit 104A.

The verification information only needs to be any information that can be used for authenticity determination. The data format of the verification information is not particularly limited. Multimodal data including data in a plurality of data formats may be used as the verification information. For example, the verification information acquisition unit 105A may search a website based on the text acquired from at least one of the textualizing unit 101A and the acquisition unit 104A, and acquire text data, image data, audio data, and video data included in the website included in the search result as multimodal verification information. In addition, the verification information acquisition unit 105A may search images, audios, and videos on the Internet based on the text acquired from at least one of the textualizing unit 101A and the acquisition unit 104A, and acquire image data, audio data, and video data as search results. The search target is freely set. For example, the verification information acquisition unit 105A may search a predetermined database, data lake, or the like.

The verification information acquisition unit 105A may instruct the LLM to generate a word or a search formula to be used for search, based on the text acquired from at least one of the textualizing unit 101A and the acquisition unit 104A. The verification information acquisition unit 105A may perform the above search by using the word or the search formula generated by the LLM.

The verification information acquisition unit 105A may search a website in a multimodal manner based on the image, the audio, or the video as the non-text element acquired by the acquisition unit 104A, and acquire text data, image data, audio data, or video data included in the website included in the search result as multimodal verification information. The verification information acquisition unit 105A may search for an image, audio, and a video on the Internet similar to each piece of modal data via the acquisition unit 104A based on the image, the audio, and the video as the non-text elements acquired by the acquisition unit 104A, and acquire image data, audio data, and video data as search results.

The verification information acquisition unit 105A may acquire the verification information from the search results from the top to a predetermined rank in the above external information search.

Furthermore, for example, the verification information acquisition unit 105A may acquire the verification information input by the user of the information processing apparatus 1A via the communication unit 12A or the input unit 13A. The verification information acquisition unit 105A may acquire, as the verification information, internal information such as data stored in advance in the storage unit 11A of the information processing apparatus 1A or data stored in a private network in which the information processing apparatus 1A exists.

In a case where the internal information is used as the verification information, the verification information acquisition unit 105A does not need to perform search. The verification information acquisition unit 105A may search for internal information to be used as the verification information. As a search method, a method similar to the case of using the external information as the verification information can be applied.

The verification information acquisition unit 105A may perform both the search for the external information described above and the acquisition of the internal information described above. That is, the verification information acquisition unit 105A may use both the information acquired by the search and the information acquired without the search, as the verification information.

The non-text element included in the multimodal verification information acquired by the verification information acquisition unit 105A in the above-described manner is textualized by the textualizing unit 101A. Here, in a case where the text obtained by textualization is too long or redundant, processing such as summarizing the text by inputting the text into the LLM may be performed. In a case where there are a plurality of text elements included in the verification information acquired by the verification information acquisition unit 105A in the above-described manner, the text elements may be combined to form one text. Similarly, in a case where there are a plurality of texts generated by the textualizing unit 101A, the texts may be combined to form one text. Furthermore, the text element included in the verification information and the text generated by the textualizing unit 101A may be combined to form one text. In these cases, the authenticity determination is made by using the integrated text. Any integration method is used. For example, the descriptions of each text may be integrated in a simple side-by-side manner, or may be integrated in a manner that the LLM generates a summary of the details of a plurality of texts.

Similarly to the authenticity determination unit 103 in the first example embodiment, the authenticity determination unit 103A determines the authenticity of the assertion details extracted by the extraction unit 102A. Here, the authenticity determination unit 103A acquires the text indicating the assertion details of the content as the target of the authenticity determination, which has first been extracted by the extraction unit 102A. The authenticity determination unit 103A acquires the verification information as the basis for the authenticity determination from the verification information acquisition unit 105A.

The authenticity determination unit 103A generates an output indicating validity of the assertion details by inputting, to the LLM that is a machine-learned language model, the text indicating the assertion details of the content and verification information for verifying the authenticity of the assertion details, and determines the authenticity of the assertion details based on the output. That is, the authenticity determination unit 103A generates a prompt indicating that the text indicating the assertion details extracted from the extraction unit 102A and the text as the verification information that serves as the basis of the authenticity determination acquired from the verification information acquisition unit 105A are used as inputs, and the authenticity determination result of the assertion details is used as an output, and inputs the generated prompt to the LLM. The authenticity determination result may be indicated by a binary value of “true” or “false”, or may be indicated by evaluation results of a plurality of levels such as “true”, “slightly true”, “slightly false”, and “false”. As the authenticity determination result, the degree of likelihood of “true” may be indicated by a numerical value (0 to 100 or the like).

The authenticity determination unit 103A may divide the text representing the assertion details into a plurality of pieces, determine authenticity for each portion, and comprehensively determine the authenticity from the determination results.

An example of the prompt includes details as follows. “The assertion details obtained from the content and the evidence for determining the authenticity of the assertion details are given. Your job is to determine whether the assertion details are correct based on the evidence. The determination is made by selection of either “true” or “false”.”

The above prompt includes the text indicating the assertion details extracted from the extraction unit 102A and the text as the verification information that serves as the basis of the authenticity determination, which is acquired from the verification information acquisition unit 105A. If such a prompt is input to the LLM, the authenticity determination result of the assertion details of the content is output from the LLM.

The text input to the LLM may include the text that is the source of the text in addition to the text indicating the assertion details. For example, it is assumed that the content as the target of the authenticity determination includes an image and a first text. In addition, it is assumed that the textualizing unit 101A generates a second text from this image. It is assumed that a fourth text indicating the assertion details of the content is generated from a third text obtained by integrating the first text and the second text. In this case, the text input to the LLM at the time of authenticity determination may include at least one of the first to third texts in addition to the fourth text.

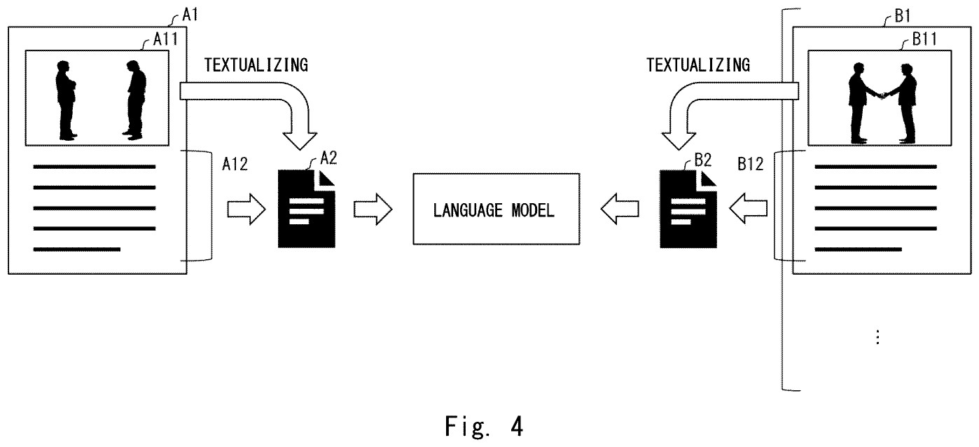

FIG. 4 is a diagram illustrating an authenticity determination example using the LLM (language model). In the example of FIG. 4, an integrated text A2 in which a text generated by the textualizing unit 101A with respect to a non-text element A11 included in a content A1 and a text element A12 included in the content are integrated is generated. The integrated text A2 indicates the assertion details of the content A1.

Both the generation of the text from the non-text element A11 and the generation of the integrated text A2 can be performed by using the LLM. The LLM used for the above processing may be the same as or different from the LLM used for the authenticity determination. In particular, for generation of text from the non-text element A11, it is preferable to use a generation model according to the data format of the non-text element A11. The same applies to generation of a text from a non-text element B11 and generation of an integrated text B2, which will be described below.

Furthermore, in the example of FIG. 4, a plurality of pieces of verification information are used to determine the authenticity of the assertion details of the content A1. The verification information B1 that is one of the plurality of pieces of verification information includes the non-text element B11. Therefore, the textualizing unit 101A textualizes the non-text element B11. The integrated text B2 in which the text generated from the non-text element B11 and the text element B12 included in the verification information B1 are integrated is generated. The integrated text B2 indicates the description details of the verification information B1. Although not illustrated, similarly to the verification information B1, a text indicating the details of other pieces of verification information is generated. The verification information that does not include the non-text element is used as it is for verification.

In the verification, the authenticity determination unit 103A inputs, to the LLM, the integrated text A2 generated in the above-described manner and the integrated text B2 (and the text indicating the details of the other pieces of verification information). As a result, the authenticity determination result is output from the LLM.

The report generation unit 106A generates a report including a determination result of the authenticity of the assertion details and basis information indicating the basis of the determination result. For example, the report generation unit 106A may input, to the LLM, the description of a verification target and information indicating the verification process in addition to the determination result of the authenticity determination unit 103A, and cause the LLM to generate a report including the description of the verification target, the verification process, the verification result, and the reason of the verification result.

Furthermore, instead of providing the report generation unit 106A, the authenticity determination unit 103A may cause the LLM to generate a report including the above-described basis information in addition to the result of the authenticity determination. An example of the prompt in this case includes details as follows. “An input including a combination of a text, an image, audio, and a video, an assertion including the input, evidence to determine the authenticity of the assertion, and the description of evidence search details are given. Your job is to determine whether the assertion of the input is correct based on the evidence and generate a report. The report is caused to include three items of “verification target”, “verification process”, and “determination result”, and please explain the input and assertion in “verification target”. In “verification process”, please explain the process of the fact checking performed by you in sentences. In “determination result”, please select the determination result of the fact checking from “true” and “false”. Then, please explain the reason for the determination in detail.”

In addition, the above prompt includes the text generated by the textualizing unit 101A, the text indicating the assertion details extracted by the extraction unit 102A, the text describing the search details performed by the verification information acquisition unit 105A, and the text as the verification information that serves as the basis of the authenticity determination, which is acquired from the verification information acquisition unit 105A. If such a prompt is input to the LLM, a report indicating the authenticity determination result of the assertion details of the content and the basis information is output from the LLM.

The text describing the search details can be generated by inputting various types of information indicating the search details (various types of information used in the search process) to the LLM. The LLM can be caused to generate an explanatory sentence of the search result. A word (search word) used for search, a search formula, a text indicating a search target, or the like may be used as the text describing the search details.

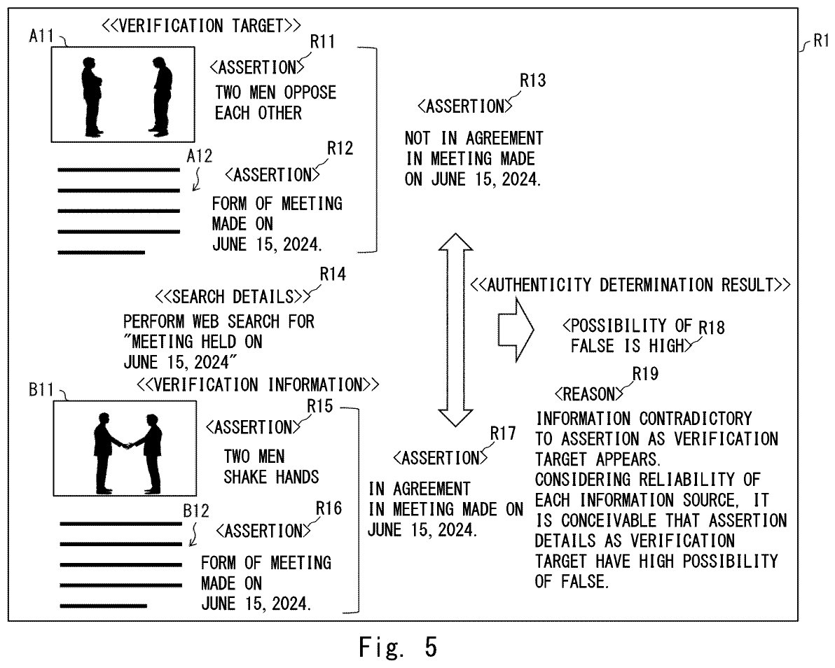

FIG. 5 illustrates an example of the report generated by the report generation unit 106A. In the column of a verification target in a report R1 illustrated in FIG. 5, an image corresponding to a non-text element Al1, a text element A12, an assertion R11 generated based on the non-text element A11, and an assertion R12 generated based on the text element A12 are shown for a content A1 as the target of the authenticity determination. An assertion R13 that is generated based on the assertion R11 and the assertion R12 and corresponds to the content A1 is also shown.

Search details R14 at the time of acquiring verification information B1 are shown in the report R1. In the column of the verification information acquired based on the search details R14, an image corresponding to a non-text element B11, a text element B12, an assertion R15 generated based on the non-text element B11, and an assertion R16 generated based on the text element B12 are shown for the verification information B1. An assertion R17 that is generated based on the assertion R15 and the assertion R16 and corresponds to the verification information B1 is also shown.

Furthermore, the authenticity determination result R18 and the reason R19 of the authenticity determination result are illustrated in the field of the authenticity determination result output from the LLM using the assertion R13 corresponding to the content A1 and the assertion R17 corresponding to the verification information B1 as inputs.

In the example illustrated in FIG. 5, regarding “verification process”, the flow of the verification process is shown depending on the arrangement position of each column, arrows, and the like. The present invention is not limited to this, and the verification process may be shown by sentences.

The report generation unit 106A may generate such a report by inputting a prompt for an instruction of a report including each of the above items to the LLM. The report generation unit 106A may generate the description in each item by inputting a prompt for an instruction to generate the description in each item to the LLM. For example, a reason R19 in FIG. 5 can be generated by inputting the authenticity determination result and the verification information to the LLM. In this case, the report generation unit 106A only needs to generate the report by combining the generated descriptions.

The report generation unit 106A may generate a report including only the determination result of the authenticity of the assertion details. The report generation unit 106A may generate a report including the basis information indicating the basis of the determination result in response to an instruction from the user after generating a report including only the determination result of the authenticity of the assertion details. The report generation unit 106A may output how much the authenticity determination unit 103A has emphasized each piece of the data acquired as the verification information. This may be acquired by the report generation unit 106A inquiring the LLM.

The presentation control unit 107A presents the report generated by the report generation unit 106A to the user. For example, the presentation control unit 107A may display the report on a display device connected to the information processing apparatus 1A via the output unit 14A, or may transmit data indicating the report to an information processing terminal used by the user via a communication network via the communication unit 12A.

### (Verification Method)

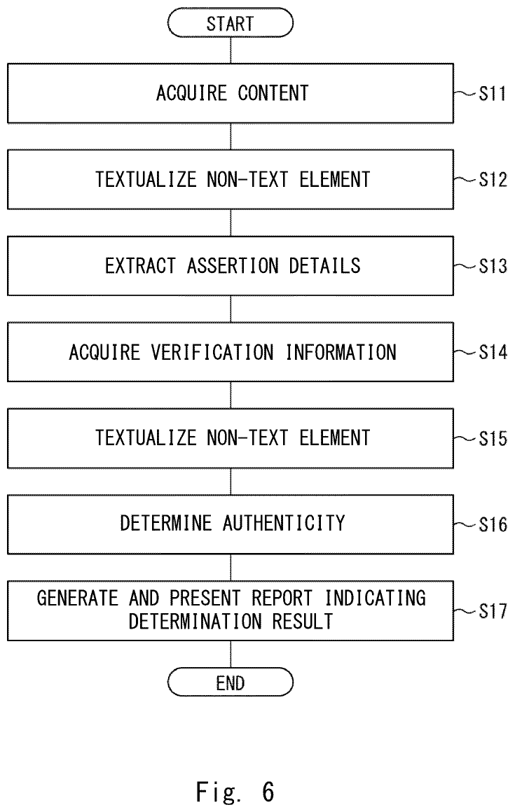

A flow of processing performed by the information processing apparatus 1A will be described with reference to FIG. 6. FIG. 6 is a flowchart illustrating an example of the processing performed by the information processing apparatus 1A. FIG. 6 includes processes of the verification method according to the present example embodiment.

In S11, the acquisition unit 104A acquires a content that is a target for determining the authenticity of the assertion details. In S12, the textualizing unit 101A textualizes a non-text element included in the content acquired in S11. In a case where the content acquired in S11 includes a text element and a non-text element, the textualizing unit 101A may generate one text by integrating the text element and the textualized non-text element.

In S13, the extraction unit 102A extracts assertion details of the content from the non-text element textualized by the textualizing unit 101 in S12 and a text element included in the content acquired in S11. In this case, the extraction unit 102A may set each of the assertion details extracted from the textualized non-text element and the assertion details extracted from the text element, as the assertion details of the content. The extraction unit 102A may generate assertion details as the entirety of the content from the assertion details extracted from the textualized non-text element and the assertion details extracted from the text element. The assertion details as a whole can be generated by the LLM. In a case where one text is generated in S12 by integrating the text element and the textualized non-text element, the extraction unit 102A can extract the assertion details as the entirety of the content from the one text.

In S14, the verification information acquisition unit 105A acquires verification information as a basis for the authenticity determination by the authenticity determination unit 103A. As described above, the verification information acquisition unit 105A may acquire external information detected by the search as the verification information, may acquire internal information input to the information processing apparatus 1A as the verification information, or may acquire both the external information and the internal information as the verification information. For example, in a case where the verification information is acquired by the search, the verification information acquisition unit 105A performs the search based on at least any one of the text generated in S12, the text element included in the content acquired in S11, and the non-text element included in the content acquired in S11, and acquires the verification information.

In S15, the textualizing unit 101A textualizes the non-text element included in the verification information acquired in S14. In a case where one piece of verification information includes a text element and a non-text element, a text indicating assertion details of the verification information as a whole may be generated from the textualized non-text element and the text element. This is similar to the case of extracting the assertion details of the content which is the target of the authenticity determination. In a case where the non-text element is not included in the verification information acquired in S14, the process of S15 is omitted.

In S16, the authenticity determination unit 103A determines the authenticity of the assertion details extracted in S13 by using the verification information acquired in S14 and the text generated in S15. As described above, the text indicating the assertion details of the verification information as a whole may be generated from the text element included in one piece of verification information and the text generated from the non-text element included in the verification information. In this case, the authenticity determination is made using the text indicating the assertion details of the verification information as a whole. In a case where a plurality of pieces of verification information are acquired in S14, the authenticity determination is made using the plurality of pieces of verification information.

In S17, the report generation unit 106A generates a report including a determination result of the authenticity of the assertion details and basis information indicating the basis of the determination result. The presentation control unit 107A presents the report generated by the report generation unit 106A to the user.

In a case where a plurality of texts indicating the assertion details are extracted in S13, the processes of S14 to S16 are repeated for each assertion details. In this case, a report indicating an authenticity determination result for each assertion details may be generated and presented. In this case, authenticity may be comprehensively determined from each determination result.

### (Effects of Information Processing Apparatus 1A)

As described above, the information processing apparatus 1A adopts a configuration in which the textualizing unit 101A textualizes a non-text element of a content including a text element and the non-text element, and the extraction unit 102A extracts assertion details of the content from the textualized non-text element and the text element. Therefore, according to the information processing apparatus 1A, in addition to the effects obtained by the information processing apparatus 1, it is possible to obtain an effect that the authenticity determination for the assertion details of a multimodal content including a text element and a non-text element can be made in consideration of both the text element and the non-text element.

The information processing apparatus 1A adopts a configuration in which the textualizing unit 101A textualizes a non-text element included in the verification information for verifying the authenticity of the assertion details, and the authenticity determination unit 103A determines the authenticity of the assertion details by using the textualized non-text element in the verification information. Therefore, according to the information processing apparatus 1A, in addition to the effect obtained by the information processing apparatus 1, it is possible to determine the authenticity of the assertion details in consideration of the information shown in the non-text element of the verification information, and it is possible to obtain an effect of improving the accuracy of the authenticity determination. In a case where the verification information includes a text element and a non-text element, the authenticity determination unit 103A may determine the authenticity of the assertion details by using at least one of the text element and the textualized non-text element.

The information processing apparatus 1A adopts a configuration including the report generation unit 106A that generates a report including a determination result of the authenticity of the assertion details and basis information indicating the basis of the determination result. Therefore, according to the information processing apparatus 1A, in addition to the effect exhibited by the information processing apparatus 1, it is possible to obtain an effect that the determination result can be presented together with information useful for the user to determine the validity of the determination result as the basis of the determination result.

The information processing apparatus 1A adopts a configuration in which the authenticity determination unit 103A generates an output indicating validity of the assertion details by inputting, to the machine-learned language model, a text indicating the assertion details of the content and verification information for verifying the authenticity of the assertion details, and determines the authenticity of the assertion details based on the output. Therefore, according to the information processing apparatus 1A, it is possible to obtain an effect that it is possible to quickly and accurately perform the authenticity determination by using the language model.

### Third Example Embodiment

A third example embodiment that is an example of an example embodiment of the present invention will be described in detail with reference to the drawings. Components having the same functions as the components described in the above-described example embodiment are denoted by the same reference numerals, and the description thereof will be appropriately omitted. An application range of each technique adopted in the present example embodiment is not limited to the present example embodiment. That is, each technique adopted in the present example embodiment can also be adopted in the other example embodiments included in the present disclosure within a range in which no particular technical problem occurs. In addition, each technique illustrated in each of the drawings referred to for describing the present example embodiment can be adopted in the other example embodiments included in the present disclosure within a range in which no particular technical problem occurs.

### (Configuration of Coverage Content Verification Apparatus 1B)

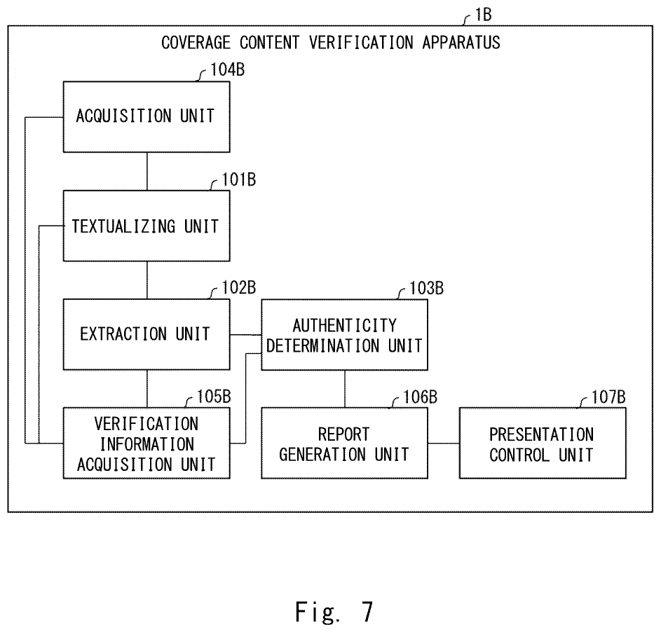

A configuration of a coverage content verification apparatus 1B according to the present example embodiment will be described with reference to FIG. 7. FIG. 7 is a block diagram illustrating a configuration of the coverage content verification apparatus 1B. The coverage content verification apparatus 1B includes an acquisition unit 104B, a textualizing unit 101B, an extraction unit 102B, an authenticity determination unit 103B, a verification information acquisition unit 105B, a report generation unit 106B, and a presentation control unit 107B.

The coverage content verification apparatus 1B is an apparatus that determines the authenticity of assertion details of a content of a coverage target. Here, the content of a coverage target may be a content scheduled to be covered or content after being covered. The coverage content verification apparatus 1B is used in a coverage organization to determine the authenticity of coverage details by the coverage organization.

Similarly to the acquisition unit 104A in the second example embodiment, the acquisition unit 104B acquires the content that is a target for determining the authenticity of the assertion details. In the present example embodiment, an article about to be covered in the company or an article covered in the past is assumed as the content. Examples of information for specifying the content include information indicating a storage place of a specific content file including data of an article as a verification target. In the case of an article published on the Internet in the past, URL information may be used as the information for specifying the content.

Similarly to the textualizing unit 101A in the second example embodiment, the textualizing unit 101B textualizes a non-text element included in a content that is a target for determining the authenticity of the assertion details.

Similarly to the extraction unit 102A in the second example embodiment, the extraction unit 102B extracts assertion details of the content from the non-text element textualized by the textualizing unit 101B and a text element included in the content.

Similarly to the verification information acquisition unit 105A in the second example embodiment, the verification information acquisition unit 105B acquires verification information as a basis of the authenticity determination by the authenticity determination unit 103B based on at least one of the text generated by the textualizing unit 101B, the text as the text element included in the content acquired by the acquisition unit 104B, and the non-text element included in the content acquired by the acquisition unit 104B.

Here, the verification information is acquired from the external information and the internal information described in the second example embodiment. In particular, as the internal information, an internal file group, an internal database, or the like that stores an interview result performed by a coverage organization that intends to cover or has covered the content may be used. By using such internal information of the coverage organization as the verification information, it is possible to improve the reliability of the authenticity determination result.

Similarly to the authenticity determination unit 103A in the second example embodiment, the authenticity determination unit 103B determines the authenticity of the assertion details extracted by the extraction unit 102B.

Similarly to the report generation unit 106A in the second example embodiment, the report generation unit 106B generates a report including a determination result of the authenticity of the assertion details and basis information indicating the basis of the determination result. The report generated by the report generation unit 106B may include information indicating a risk of covering the content of the coverage target. For example, in a case where the LLM is caused to determine which of a plurality of stages the possibility that the assertion details are “true” corresponds to, the report generation unit 106B may include information indicating a risk corresponding to the stage in the report.

The presentation control unit 107B presents the report generated by the report generation unit 106B to the user, similarly to the presentation control unit 107A in the second example embodiment.

Since a verification method in the present Example Embodiment 3 is similar to the verification method described in the second example embodiment with reference to FIG. 6, the description thereof is omitted here.

As described above, the coverage content verification apparatus 1B adopts a configuration including the textualizing unit 101B that textualizes a non-text element included in a content of a coverage target, the extraction unit 102B that extracts assertion details of the content from the textualized non-text element, and the authenticity determination unit 103B that determines authenticity of the extracted assertion details. Therefore, according to the coverage content verification apparatus 1B, it is possible to obtain an effect that it is possible to provide a technique of automatically determining the authenticity of the coverage details in consideration of the non-text element included in the content of the coverage target.

### (Coverage Content Verification Program)

The above-described functions of the coverage content verification apparatus 1B can also be implemented by a program. A coverage content verification program according to the present example embodiment causes a computer to function as the textualizing unit 101B that textualizes a non-text element included in a content of a coverage target, the extraction unit 102B that extracts assertion details of the content from the textualized non-text element, and the authenticity determination unit 103B that determines authenticity of the extracted assertion details. According to this coverage content verification program, it is possible to obtain an effect that it is possible to provide a technique of automatically determining the authenticity of coverage details in consideration of the non-text element included in the content of the coverage target.

### (Coverage Content Verification Method)

In a coverage content verification method according to the present example embodiment, at least one processor performs textualizing processing of textualizing a non-text element included in a content of a coverage target, extraction processing of extracting assertion details of the content from the textualized non-text element, and authenticity determination processing of determining authenticity of the extracted assertion details. According to this coverage content verification method, it is possible to obtain an effect that it is possible to provide a technique of automatically determining the authenticity of coverage details in consideration of the non-text element included in the content of the coverage target.

### Fourth Example Embodiment

A fourth example embodiment that is an example of an example embodiment of the present invention will be described in detail with reference to the drawings. Components having the same functions as the components described in the above-described example embodiment are denoted by the same reference numerals, and the description thereof will be appropriately omitted. An application range of each technique adopted in the present example embodiment is not limited to the present example embodiment. That is, each technique adopted in the present example embodiment can also be adopted in the other example embodiments included in the present disclosure within a range in which no particular technical problem occurs. In addition, each technique illustrated in each of the drawings referred to for describing the present example embodiment can be adopted in the other example embodiments included in the present disclosure within a range in which no particular technical problem occurs.

### (Configuration of Statement Details Verification Apparatus 1C)

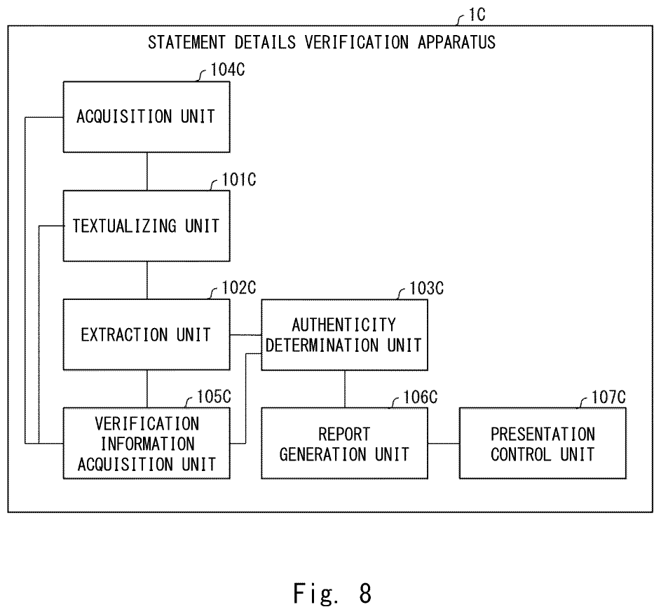

A configuration of a statement details verification apparatus 1C according to the present example embodiment will be described with reference to FIG. 8. FIG. 8 is a block diagram illustrating the configuration of the statement details verification apparatus 1C. The statement details verification apparatus 1C includes an acquisition unit 104C, a textualizing unit 101C, an extraction unit 102C, an authenticity determination unit 103C, a verification information acquisition unit 105C, a report generation unit 106C, and a presentation control unit 107C.

The statement details verification apparatus 1C is an apparatus that determines the authenticity of statement details. The statement details verification apparatus 1C is used in the police, the public prosecutor, the court, and the like to determine the authenticity of the statement details of a suspect, a defendant, and the like. In general, “statement” means to state a fact or an opinion in response to an interrogation by a judge, a public prosecutor, or the like. However, “statement” in the present example embodiment includes, in addition to the general statements described above, general statements in the police, the public prosecutor, the court, and the like including statement details by police officers and the like.

Similarly to the acquisition unit 104A in the second example embodiment, the acquisition unit 104C acquires the content that is a target for determining the authenticity of the assertion details. In the present example embodiment, a content indicating statement details is acquired as a content that is a target of the authenticity determination. For example, the acquisition unit 104C acquires data obtained by recording a statement, data obtained by recording a form of a statement, and the like. The acquisition unit 104C may acquire a statement record, an investigation material, or the like including an image that supports statement details, as the content that is the target of the authenticity determination.

Similarly to the textualizing unit 101A in the second example embodiment, the textualizing unit 101C textualizes a non-text element included in a content that is a target for determining the authenticity of the assertion details. For example, it is assumed that the acquisition unit 104C acquires data obtained by recording a statement as the content that is a target of the authenticity determination. In this case, the textualizing unit 101C textualizes the data obtained by recording the statement.

Similarly to the extraction unit 102A in the second example embodiment, the extraction unit 102C extracts the assertion details of the content from the non-text element textualized by the textualizing unit 101C. In a case where a text element is included in the content as the target of the authenticity determination, the extraction unit 102C may extract the assertion details in consideration of the text element.

Similarly to the verification information acquisition unit 105A in the second example embodiment, the verification information acquisition unit 105C acquires verification information as a basis for the authenticity determination. Here, the verification information is acquired from the external information and the internal information described in the second example embodiment. In particular, weather information, news information, traffic information, and the like at the time of an occurrence of an incident may be used as the external information. An intra-organization file group, an intra-organization database, or the like that stores an investigation material in the police or public prosecutor, an image captured by a surveillance camera, or the like may be used as the internal information.

Similarly to the authenticity determination unit 103A in the second example embodiment, the authenticity determination unit 103C determines the authenticity of the assertion details extracted by the extraction unit 102C.

Similarly to the report generation unit 106A in the second example embodiment, the report generation unit 106C generates a report including a determination result of the authenticity of the assertion details and basis information indicating the basis of the determination result.

The presentation control unit 107C presents the report generated by the report generation unit 106C to the user, similarly to the presentation control unit 107A in the second example embodiment.

Since a verification method in the present Example Embodiment 4 is similar to the verification method described in the second example embodiment with reference to FIG. 6, the description thereof is omitted here.

As described above, the statement details verification apparatus 1C adopts a configuration including the textualizing unit 101C that textualizes a non-text element of a content indicating statement details, the extraction unit 102C that extracts the statement details from the textualized non-text element, and the authenticity determination unit 103C that determines the authenticity of the extracted statement details. Therefore, according to the statement details verification apparatus 1C, it is possible to obtain an effect that it is possible to provide a technique of automatically determining the authenticity of the statement details in consideration of the non-text element included in the content indicating the statement details.

### (Statement Details Verification Program)

The above-described functions of the statement details verification apparatus 1C can also be implemented by a program. A statement details verification program according to the present example embodiment causes a computer to function as the textualizing unit 101C that textualizes a non-text element included in a content of a coverage target, the extraction unit 102C that extracts assertion details of the content from the textualized non-text element, and the authenticity determination unit 103C that determines authenticity of the extracted assertion details. According to this statement details verification program, it is possible to obtain an effect that it is possible to provide a technique of automatically determining the authenticity of statement details in consideration of the non-text element included in the content indicating the statement details.

### (Statement Details Verification Method)

In a statement details verification method according to the present example embodiment, at least one processor performs textualizing processing of textualizing a non-text element included in a content of a coverage target, extraction processing of extracting assertion details of the content from the textualized non-text element, and authenticity determination processing of determining authenticity of the extracted assertion details. According to this statement details verification method, it is possible to obtain an effect that it is possible to provide a technique of automatically determining the authenticity of statement details in consideration of the non-text element included in the content indicating the statement details.

### Modified Examples

Any execution subject of processing described in the above-described example embodiments is set, and the execution subject is not limited to the above-described examples. For example, a system having functions similar to the functions of the information processing apparatus 1 or 1A, the coverage content verification apparatus 1B, and the statement details verification apparatus 1C can be constructed by a plurality of devices capable of communicating with each other. The execution subject of processing illustrated in the flowchart illustrated in FIG. 6 may be one device (also referred to as a processor) or a plurality of devices (also referred to as a processor).

### [Example of Implementation by Software]

Some or all of the functions of the information processing apparatus 1 or 1A, the coverage content verification apparatus 1B, and the statement details verification apparatus 1C may be implemented by hardware such as an integrated circuit (IC chip) or may be implemented by software.

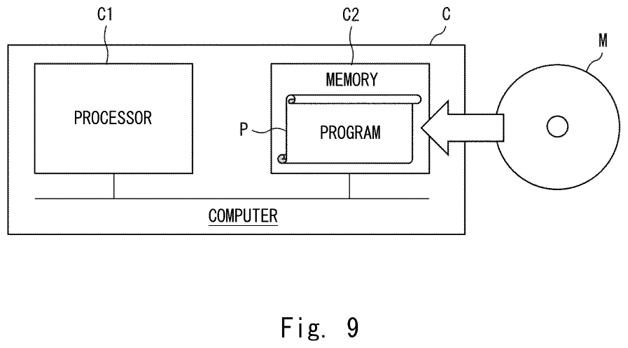

In the latter case, the information processing apparatus 1 or 1A, the coverage content verification apparatus 1B, and the statement details verification apparatus 1C are implemented by, for example, a computer that executes commands of a program that is software for implementing each function. FIG. 9 illustrates an example of such a computer (hereinafter, referred to as a computer C). FIG. 9 is a block diagram illustrating a hardware configuration of the computer C that functions as the information processing apparatus 1 or 1A, the coverage content verification apparatus 1B, or the statement details verification apparatus 1C.

The computer C includes at least one processor C1 and at least one memory C2. In the memory C2, a program (analysis program) P for causing the computer C to operate as the information processing apparatus 1 or 1A, the coverage content verification apparatus 1B, or the statement details verification apparatus 1C is recorded. In the computer C, the processor C1 reads and executes the program P from the memory C2, thereby implementing the functions of the information processing apparatus 1 or 1A, the coverage content verification apparatus 1B, or the statement details verification apparatus 1C.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for developing the program P at the time of execution and temporarily storing various types of data. The computer C may further include a communication interface for transmitting and receiving data to and from other apparatuses. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

All the above-described functions of the information processing apparatus 1 or 1A, the coverage content verification apparatus 1B, or the statement details verification apparatus 1C may be implemented by a single processor provided in a single computer, may be implemented by cooperation of a plurality of processors provided in a single computer, or may be implemented by cooperation of a plurality of processors provided in a plurality of computers. The program for causing the information processing apparatus 1 or 1A, the coverage content verification apparatus 1B, or the statement details verification apparatus 1C to implement the above-described functions may be stored in a single memory provided in a single computer, may be stored in a distributed manner in a plurality of memories provided in a single computer, or may be stored in a distributed manner in a plurality of memories provided in a plurality of computers.

### Supplementary Notes

The present disclosure includes the technologies described in the following supplementary notes. However, the present invention is not limited to the technologies described in the following supplementary notes, and various modifications can be made within the scope described in the claims.

### Supplementary Note 1

An information processing apparatus including: textualizing means for textualizing a non-text element included in a content that is a target for determining authenticity of assertion details; extraction means for extracting assertion details of the content from the textualized non-text element; and authenticity determination means for determining authenticity of the extracted assertion details.

### Supplementary Note 2

The information processing apparatus according to Supplementary Note 1, in which the textualizing means textualizes a non-text element of the content including a text element and the non-text element, and the extraction means extracts the assertion details of the content from the textualized non-text element and the text element.

### Supplementary Note 3

The information processing apparatus according to Supplementary Note 1 or 2, in which the textualizing means textualizes a non-text element included in verification information for verifying the authenticity of the assertion details, and the authenticity determination means determines the authenticity of the assertion details by using the textualized non-text element in the verification information.

### Supplementary Note 4

The information processing apparatus according to any one of Supplementary Notes 1 to 3, further including report generation means for generating a report including a determination result of the authenticity of the assertion details and basis information indicating a basis of the determination result.

### Supplementary Note 5

The information processing apparatus according to any one of Supplementary Notes 1 to 4, in which the authenticity determination means generates an output indicating validity of the assertion details by inputting, to a machine-learned language model, a text indicating the assertion details of the content and verification information for verifying the authenticity of the assertion details, and determines the authenticity of the assertion details based on the output.

### Supplementary Note 6A

An information processing apparatus used in a fact checking institution that performs fact checking of a content, the information processing apparatus including: textualizing means for textualizing a non-text element included in the content; extraction means for extracting assertion details of the content from the textualized non-text element; and authenticity determination means for determining authenticity of the extracted assertion details.

### Supplementary Note 6

A coverage content verification apparatus including: textualizing means for textualizing a non-text element included in a content that is a coverage target; extraction means for extracting assertion details of the content from the textualized non-text element; and authenticity determination means for determining authenticity of the extracted assertion details.

### Supplementary Note 6B

The coverage content verification apparatus according to Supplementary Note 6, in which the authenticity determination means determines the authenticity of the assertion details by using verification information indicating a past interview result associated with the assertion details.

### Supplementary Note 7

A statement details verification apparatus including: textualizing means for textualizing a non-text element of a content indicating statement details; extraction means for extracting the statement details from the textualized non-text element; and authenticity determination means for determining authenticity of the extracted statement details.

### Supplementary Note 8

A verification method including: by at least one processor, textualizing a non-text element included in a content that is a target for determining authenticity of assertion details; extracting assertion details of the content from the textualized non-text element; and determining authenticity of the extracted assertion details.

### Supplementary Note 9

A verification program causing a computer to function as: textualizing means for textualizing a non-text element included in a content that is a target for determining authenticity of assertion details; extraction means for extracting assertion details of the content from the textualized non-text element; and authenticity determination means for determining authenticity of the extracted assertion details.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

1. An information processing apparatus comprising:
at least one memory storing computer-executable instructions; and
at least one processor configured to access the at least one memory and execute the computer-executable instructions to:
(a) textualize a non-text element included in a content that is a target for determining authenticity of assertion details;
(b) extract assertion details of the content from the textualized non-text element; and
(c) determine authenticity of the extracted assertion details.

2. The information processing apparatus according to claim 1, wherein
the at least one processor is further configured to textualize a non-text element of the content including a text element and the non-text element and to extract the assertion details of the content from the textualized non-text element and the text element.

3. The information processing apparatus according to claim 1, wherein
the at least one processor is further configured to textualize a non-text element included in verification information for verifying the authenticity of the assertion details and to determine the authenticity of the assertion details by using the textualized non-text element in the verification information.

4. The information processing apparatus according to claim 1, wherein
the at least one processor is further configured to generate a report including a determination result of the authenticity of the assertion details and basis information indicating a basis of the determination result.

5. The information processing apparatus according to claim 1, wherein
the at least one processor is further configured to generate an output indicating validity of the assertion details by inputting, to a machine-learned language model, a text indicating the assertion details of the content and verification information for verifying the authenticity of the assertion details and to determine the authenticity of the assertion details based on the output.

6. A verification method, the verification method being performed by a computer executing instructions stored in a memory, the verification method comprising:
(a) textualizing a non-text element included in a content that is a target for determining authenticity of assertion details;
(b) extracting assertion details of the content from the textualized non-text element; and
(c) determining authenticity of the extracted assertion details.

7. A non-transitory computer-readable storage medium that stores a computer-executable program, the program comprising instructions for:
(a) textualizing a non-text element included in a content that is a target for determining authenticity of assertion details;
(b) extracting assertion details of the content from the textualized non-text element; and
(c) determining authenticity of the extracted assertion details.
